(19) United States
(12) Patent Application Publication
(10) Pub. No.: US 2012/0002069 A1
(43) Pub. Date: Jan. 5, 2012

(54) IMAGING APPARATUS, IMAGING METHOD, IMAGING PROGRAM, IMAGE PROCESSING APPARATUS, IMAGE PROCESSING METHOD, AND IMAGE PROCESSING PROGRAM

(75) Inventor: Yoshimitsu TAKAGI, Kanagawa (JP)

(73) Assignee: Sony Corporation, Tokyo (JP)

(21) Appl. No.: 13/151,620

(22) Filed: Jun. 2, 2011

(30) Foreign Application Priority Data
Jul. 5, 2010 (JP) 2010-153119

(51) Int. Cl. H04N 5/228; G06K 9/36

(52) U.S. Cl. 348/222.1; 382/286; 348/E05.031

(57) ABSTRACT

An image processing apparatus includes: an addition intensity calculation unit which calculates an addition intensity on the basis of a difference between first image data included in a plurality of pieces of image data obtained through sequential shooting and second image data included in the plurality of pieces of image data; and an addition processing unit which performs addition processing of the first image data and the second image data on the basis of the addition intensity.

### FIELD

The present disclosure relates to an imaging apparatus, an imaging method, an imaging program, an image processing apparatus, an image processing method, and an image processing program.

In particular, the present disclosure relates to an imaging apparatus, an imaging method, an imaging program, an image processing apparatus, an image processing method, and an image processing program which performs correct denoising processing on a motion of a subject.

### BACKGROUND

As well known in the art, a digital camera which is an imaging apparatus has come into wide use. There is high demand in the market for the imaging ability of the digital camera. In the market, a digital camera which can take a clear and fair image compared to the related art is constantly demanded.

For a digital camera to take a clear and fair image, there are broadly two approaches. One approach is the technical innovation of an imaging device itself. Another approach is a technique for processing captured image data.

In general, if an image of any subject is taken in a dark place by a digital camera, noise is likely to appear on image data. The surface of the subject which was originally smooth is roughened due to noise, and the appearance of the captured image is damaged.

As a method of removing noise in a captured image to obtain a clear and fair image, there is a technique called “sequential shooting, addition, and noise reduction”.

The sequential shooting, addition, and noise reduction refers to a method in which (1) a plurality of pieces of still image data are obtained by sequential imaging (sequential shooting) over a short time, and (2) second or subsequent still image data are added to first still image data while being aligned with each other, thereby obtaining one piece of still image data with noise removed. JP-A-2009-104284 describes the technical content relating to the sequential shooting, addition, and noise reduction.

### SUMMARY

Amongst many kinds of sequential shooting, addition, and noise reduction in the related art as typified by JP-A-2009-104284 or the like, a known technique called block matching is used as a technique for realizing image data alignment.

Block matching acts favorably on imaging a general landscape or a person. However, the basis of block matching resides in processing for finding texture in an image, that is, the similarity of the pattern of changes in color and lightness (contrast). This means that block matching depends on texture in an image.

It may be said that, in block matching, texture is weak in a flat image. In the case of an imaging target which does not have a smooth surface such that light of a light source can be clearly reflected with little surface unevenness, texture is not easily recognized in the digital camera.

A subject with little texture corresponds to, for example, the face of a baby.

If the sequential shooting, addition, and noise reduction is carried out in a state where the face of a baby largely occupies the imaging frame of the digital camera, there is a possibility that image irregularity, such as block noise, occurs in created image data due to addition failure. Since a baby is a subject who is likely to move, in block matching, the motion vector of the subject should be recognized as information indicative of the subject in the entire image being moving, that is, “local motion”. However, since texture of the subject is poor, the motion vector of the subject may be erroneously recognized as information indicative of the entire image being moving, that is, “global motion”, causing image irregularity due to addition failure.

In order to prevent image irregularity due to addition failure, a method is considered in which block matching is carried out more strictly. However, block matching intrinsically has an enormous amount of arithmetic processing. The digital camera belongs to a typical portable embedded system (microcomputer system). Thus, as in a personal computer or the like, fast arithmetic processing may not be provided. The digital camera should resolve the above-described problem with limited arithmetic ability and power consumption.

Thus, it is desirable to provide an imaging apparatus, an imaging method, an imaging program, an image processing apparatus, an image processing method, and an image processing program capable of effectively carrying out sequential shooting, addition, and noise reduction on a subject, to which block matching is not easily applied, by adding a very small amount of arithmetic processing, suppressing image irregularity due to addition failure at that time, and realizing satisfactory imaging of still image data on most subjects.

An imaging apparatus according to an embodiment of the present disclosure includes an imaging processing unit which sequentially takes an image of a subject in response to a predetermined imaging instruction, and outputs a plurality of pieces of image data, an image memory which stores the plurality of pieces of image data, an addition intensity calculation unit which sequentially reads image data from the image memory and calculates an addition intensity based on a change between first image data and second or subsequent image data, an addition intensity table which stores the addition intensity output from the addition intensity calculation unit, a motion detection unit which sequentially reads image data from the image memory and outputs a motion vector between the first image data and the second or subsequent image data, and an addition processing unit which sequentially reads image data from the image memory and performs addition processing for adding the second or subsequent image data to the first image data on the basis of the motion vector output from the motion detection unit and the addition intensity sequentially read from the addition intensity table.

An addition intensity is calculated in advance on the basis of a change between first image data and second or subsequent image data. In performing sequential shooting and addition processing, the degree of addition changes with the addition intensity, thereby preventing image irregularity due to addition failure.

According to the embodiment of the present disclosure, it is possible to provide an imaging apparatus, an imaging method, an imaging program, an image processing apparatus, an image processing method, and an image processing program capable of effectively carrying out sequential shooting, addition, and noise reduction on a subject, to which block matching is not easily applied, by adding a very small amount of arithmetic processing, suppressing image irregularity due to addition failure at that time, and realizing satisfactory imaging of still image data on most subjects.

### BRIEF DESCRIPTION OF THE DRAWINGS

FIGS. 1A and 1B are an appearance diagram of the front surface of a digital camera and an appearance diagram of the rear surface of a digital camera.

FIG. 2 is a block diagram of hardware of a digital camera.

FIG. 3 is a functional block diagram of a digital camera.

FIG. 4 is a functional block diagram of an addition intensity calculation unit.

FIG. 5 is a functional block diagram of a developing processing unit.

FIG. 6 is a flowchart showing the flow of an operation of imaging using sequential shooting, addition, and noise reduction in a digital camera of this embodiment.

FIG. 7 is a flowchart showing the flow of an operation of addition intensity calculation processing in an addition intensity calculation unit.

FIG. 8 is a flowchart showing the flow of an operation of developing processing in a developing processing unit.

FIG. 9 is a functional block diagram of a digital camera.

FIG. 10 is a functional block diagram of an image processing apparatus.

### DETAILED DESCRIPTION

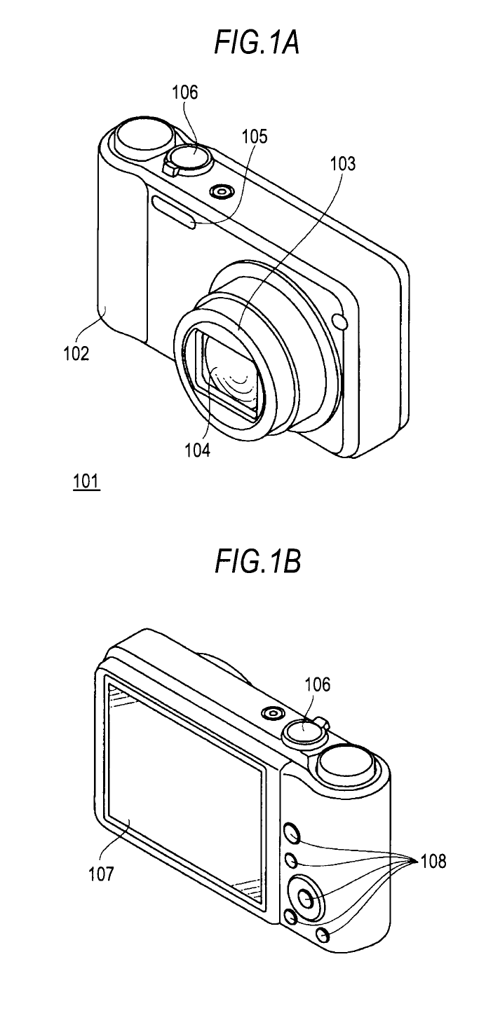

FIG. 1A is an appearance diagram of the front surface of a digital camera. FIG. 1B is an appearance diagram of the rear surface of a digital camera.

A digital camera 101 is provided with a lens barrel 103 embedded with a zoom mechanism (not shown) and a focus adjustment mechanism in the front surface of a housing 102. A lens 104 is assembled into the lens barrel 103. A flash 105 is provided on the lens barrel 103 side.

A shutter button 106 is provided on the upper side of the housing 102.

A liquid crystal display monitor 107 which also serves as a finder is provided in the rear surface of the housing 102. A plurality of operating buttons 108 are provided on the right side of the liquid crystal display monitor 107.

A cover which accommodates a flash memory serving as a nonvolatile storage is provided on the lower side of the housing 102 (not shown).

The digital camera 101 of this embodiment is a so-called digital still camera, takes an image of a subject to create still image data, and records still image data in a nonvolatile storage. The digital camera 101 also has a motion image imaging function, description of which will not be provided in this embodiment.

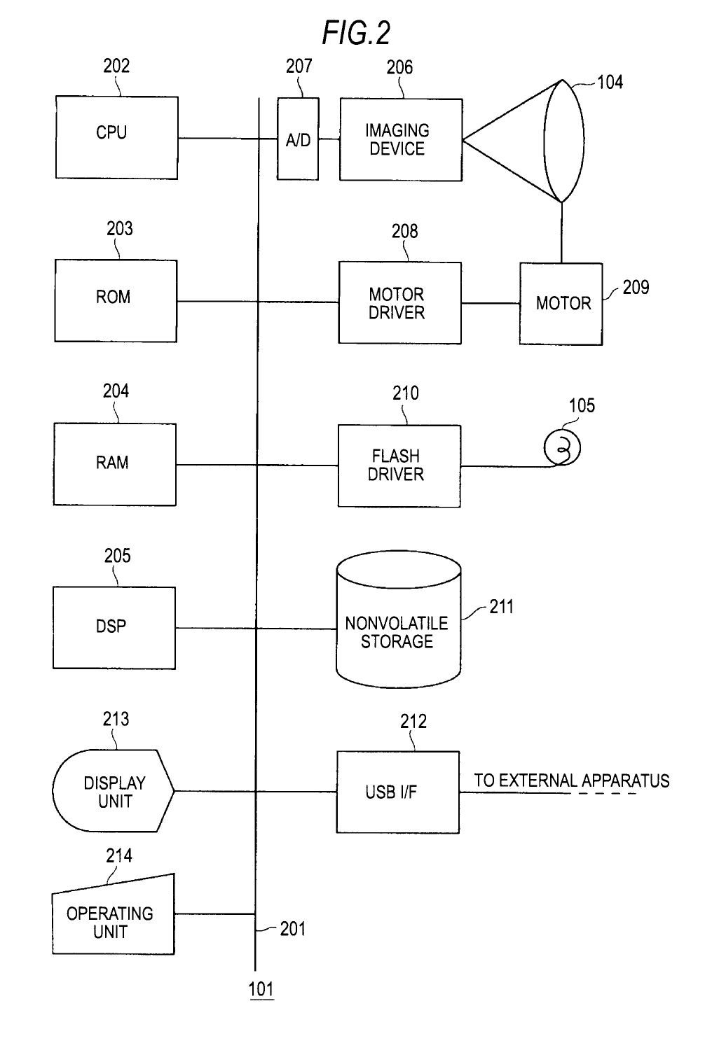

FIG. 2 is a block diagram of hardware of the digital camera 101.

The digital camera 101 constitutes a general microcomputer.

A CPU 202, a ROM 203, and a RAM 204 which are known necessary for overall control of the digital camera 101 are connected to a bus 201. A DSP 205 is also connected to the bus 201. The DSP 205 takes charge of a large quantity of arithmetic processing on a large quantity of data, such as digital image data, necessary for realizing sequential shooting, addition, and noise reduction described in this embodiment.

An imaging device 206 converts light, which is emitted from a subject focused by a lens 104, to an electrical signal. An analog signal output from the imaging device 206 is converted to an RGB digital signal by an A/D converter 207.

A motor 209 which is driven by a motor driver 208 drives the lens 104 through the lens barrel 103, and performs focus and zoom control.

A flash 105 is driven to emit light by a flash driver 210.

Captured digital image data is recorded in a nonvolatile storage 211 in the form of files.

A USB interface 212 is provided to transmit and receive files stored in the nonvolatile storage 211 with respect to an external apparatus, such as a personal computer.

A display unit 213 is the liquid crystal display monitor 107.

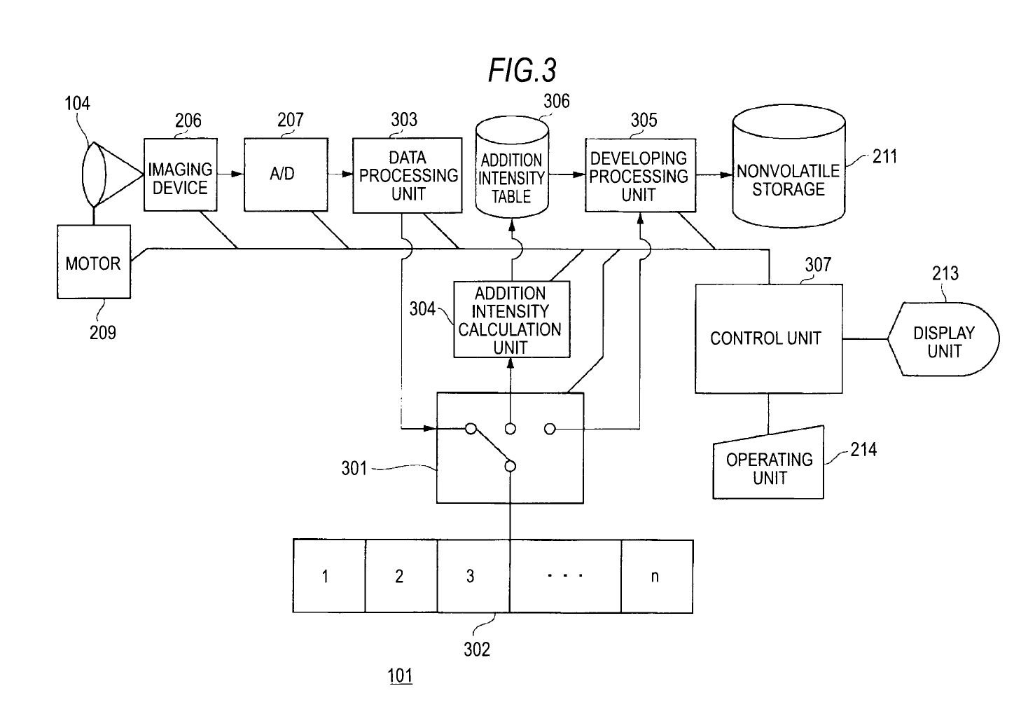

An operating unit 214 includes the shutter button 106 and the operating buttons 108. FIG. 3 is a functional block diagram of the digital camera 101.

When a selection switch 301 connects an image memory 302 and a data processing unit 303, light emitted from the subject is focused on the imaging device 206 by the lens 104 and converted to an electrical signal. After the converted signal is converted to an RGB digital signal by the A/D converter 207, the RGB digital signal is subjected to various kinds of processing, such as data sorting, defect correction, and resizing, in the data processing unit 303, and temporarily stored in the image memory 302 of the RAM 204 through the selection switch 301.

The image memory 302 has a storage capacity which corresponds to the number of times of imaging (the number of pieces) necessary for carrying out sequential shooting, addition, and noise reduction. As an example, in this embodiment, it is assumed that the storage capacity is 6 pieces (n=6).

With above, the lens 104, the imaging device 206, the A/D converter 207, and the data processing unit 303 can be regarded as an imaging processing unit which forms raw digital image data and stores raw digital image data in the image memory 302.

The selection switch 301 is not explicitly present as hardware, and is the conceptual being provided to explicitly illustrate the flow of digital image data.

The selection switch 301 is also connected to an addition intensity calculation unit 304 which is one of the important constituent elements in the present disclosure.

When the selection switch 301 connects the image memory 302 and the addition intensity calculation unit 304, the addition intensity calculation unit 304 sequentially reads six pieces of digital image data stored in the image memory 302, and roughly detects how much second or subsequent digital image data changes with respect to first digital image data. A coefficient, called “addition intensity”, indicative of the amount of addition at the time of addition processing in the developing processing unit 305 described below is created on the basis of the obtained value. The created addition intensity is sequentially stored in an addition intensity table 306 of the RAM 204.

A developing processing unit 305 is also connected to the selection switch 301.

When the selection switch 301 connects the image memory 302 and the developing processing unit 305, the developing processing unit 305 sequentially reads six pieces of digital image data stored in the image memory 302, and detects how much the second or subsequent digital image data moves with respect to the first digital image data by a known block matching algorithm in detail. Addition processing is performed on the basis of the obtained motion vector. At the time of the addition processing, the addition intensity table 306 created by the addition intensity calculation unit 304 is referenced. Digital image data is converted in a known JPEG format or the like and recorded in the nonvolatile storage 211 in the form of files.

The digital camera 101 of this embodiment carries out imaging using sequential shooting, addition, and noise reduction. Imaging using the sequential shooting, addition, and noise reduction has the following flow.

(1) First, in a state where the selection switch 301 connects the image memory 302 and the data processing unit 303, the imaging processing unit accumulates raw digital image data in the image memory 302 (imaging processing).

(2) Next, in a state where the selection switch 301 connects the image memory 302 and the addition intensity calculation unit 304, the addition intensity calculation unit 304 sequentially reads digital image data from the image memory 302, calculates an addition intensity, and stores the addition intensity in the addition intensity table 306 (addition intensity calculation processing).

(3) Finally, in a state where the selection switch 301 connects the image memory 302 and the developing processing unit 305, the developing processing unit 305 sequentially reads digital image data from the image memory 302, performs addition processing and conversion processing in a JPEG format, and records JPEG-encoded image data files in the nonvolatile storage 211 (developing processing).

A control unit 307 controls the imaging device 206, the A/D converter 207, the data processing unit 303, the addition intensity calculation unit 304, the selection switch 301, and the developing processing unit 305 in accordance with an operation or the like of the operating unit 214. An image which is formed on the imaging device 206 is displayed through the display unit 213, and various setting screens are also displayed in accordance with an operation of the operating unit 214.

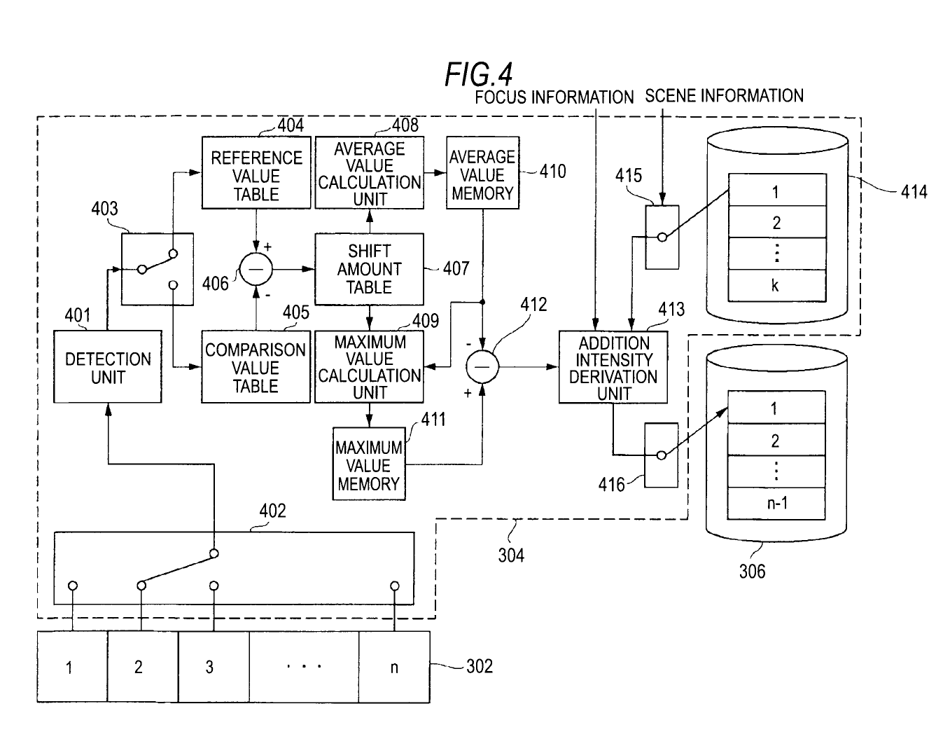

FIG. 4 is a functional block diagram of the addition intensity calculation unit 304.

The detection unit 401 performs “detection processing” for reading raw digital image data stored in the image memory 302 through a selection switch 402. In this embodiment, the detection processing is brightness calculation processing of a multi-pattern photometric frame. That is, digital image data is divided horizontally and vertically by “frames” having the same size set in advance, and the integral value of brightness of pixel data included in each frame is calculated. Data output from the detection unit 401 has the integral values of the respective photometric frames corresponding to the number of photometric frames.

A multi-pattern photometric frame is, for example, a lattice-shaped frame in which an image is divided horizontally and vertically into 20 pieces. In the case of actual processing, data of “frames” is not explicitly provided, and pixels belonging to the address of any “frame” are arranged as single arrangement data.

Although the selection switch 402 is different from the selection switch 301 of FIG. 3, similarly to the selection switch 301, the selection switch 402 is not explicitly present as hardware, and is the conceptual being provided to explicitly illustrate the flow of digital image data.

A switch 403 is connected to the output side of the detection unit 401. If the first digital image data stored in the image memory 302 is read and predetermined arithmetic processing is carried out, the detection unit 401 outputs data to a reference value table 404 through the switch 403. Similarly, with regard to the second or subsequent digital image data stored in the image memory 302, the detection unit 401 output data to a comparison value table 405 through the switch 403.

Similarly to the image memory 302, the reference value table 404 and the comparison value table 405 are provided in the RAM 204. The number of records in each of the reference value table 404 and the comparison value table 405 is the same as the number of photometric frames provided in the multi-pattern photometric frame. For this reason, when the detection unit 401 reads the second or subsequent digital image data stored in the image memory 302 and outputs data, the content of the comparison value table 405 is overwritten by the comparison value table 405 each time digital image data is read.

A first subtractor 406 subtracts the brightness value of each record stored in the comparison value table 405 from the brightness value stored in each record of the reference value table 404 for each record, and stores obtained data in a shift amount table 407. Similarly to the image memory 302, the shift amount table 407 is also provided in the RAM 204.

The value of a difference in brightness (hereinafter, referred to as “brightness difference value”) stored in each record of the shift amount table 407 is read into an average value calculation unit 408 and a maximum value calculation unit 409.

The average value calculation unit 408 calculates the average value of the brightness difference value of each record of the shift amount table 407 and stores the average value in an average value memory 410. The average value memory 410 is a variable which is provided in the RAM 204.

The maximum value calculation unit 409 compares the absolute value of the brightness difference value of each record of the shift amount table 407 with the average value stored in the average value memory 410, derives a value having a maximum difference as a maximum value, and stores the value in a maximum value memory 411. Similarly to the average value memory 410, the maximum value memory 411 is a variable which is provided in the RAM 204.

The average value stored in the average value memory 410 and the maximum value stored in the maximum value memory 411 are input to a second subtractor 412, and a value obtained by subtracting the average value from the maximum value is output. This value has a meaning of a rough motion amount of the entire image.

If there is no motion between the first digital image data as a comparison criterion and digital image data as a comparison target, the value of each record of the shift amount table 407 is “0”, the average value and the maximum value are “0”, and the output value of the second subtractor 412 is “0”. However, if there is a motion between digital image data as a comparison criterion and digital image data as a comparison target, by comparing brightness in each multi-pattern photometric frame, brightness may change in any photometric frame. The change in brightness is derived by the difference between the average value and the absolute value, thereby roughly detecting whether or not there is a motion in the entire image.

The subtracted value output from the second subtractor 412 is input to an addition intensity derivation unit 413. The addition intensity derivation unit 413 derives an addition intensity corresponding to the subtracted value with reference to a conversion table included in one record from a conversion table group 414 by scene selected by the control unit 307 through a selection pointer 415, and records the addition intensity in the addition intensity table 306. An addition intensity to be derived is changed in accordance with focus information from the control unit 307.

The conversion table group 414 by scene is provided in the ROM 203, and is a collection of conversion tables stored in each imaging scene. The conversion table refers to a table which is used for converting a subtracted value input from the second subtractor 412 to an addition intensity.

The conversion table is the correspondence table of an addition intensity corresponding to a subtracted value, in which, for example, if the subtracted value is equal to or greater than “0” and smaller than “3”, the addition intensity is set to “10”, if the subtracted value is equal to or greater than “3” and smaller than “10”, the addition intensity is set to “5”, if the subtracted value is equal to or greater than “10” and smaller than “15”, the addition intensity is set to “3”, and if the subtracted value is equal to or greater than “15”, the addition intensity is set to “0”.

An imaging scene is a selection value which is used for setting an optimum imaging state in accordance with the type of a subject, and is a function which is mounted in a recent compact digital camera or a digital camera function of a mobile phone. For example, there are “AUTO” which can flexibly cope with any subject with an average set value, “INDOOR PORTRAIT” which is optimum for an indoor person, “OUTDOOR PORTRAIT” which is optimum for an outdoor person, “OUTDOOR LANDSCAPE” which is optimum for outdoor landscape, “NIGHTSCAPE” which is optimum for nightscape, “CLOSEUP” which is optimum for closeup, “BACKLIGHT” which is optimum in a backlight state, “BABY” which is optimum for proximity imaging of a baby, and the like. The RAM 204 stores “AUTO” as a given value stored in advance in the ROM 203 by the control unit 307 or designation information of an imaging scene set by an operation of the user on the digital camera 101.

The conversion table group 414 by scene stores a conversion table optimum for an imaging scene, that is, a subject to be imaged in each record. A conversion value set in the conversion table of each record is determined taking into consideration a distance from the digital camera 101 to a subject, brightness of an imaging scene, and texture.

For example, in the case of “OUTDOOR LANDSCAPE”, since the distance from a subject is long, the motion amount of the entire image is small, and textures can be recognized clearly. Thus, the addition intensity can be set to a large value.

In the case of “BABY”, since the distance from a subject is very short, and the subject moves a lot, the motion amount of the entire image increases, making it difficult to recognize texture. For this reason, if the addition intensity is large, addition failure may occur. Thus, it is preferable to decrease the addition intensity.

The addition intensity derivation unit 413 can change an addition intensity derived from a conversion table with reference to focus information from the control unit 307.

The motion of an image occurs due to blurring of the user of the digital camera 101 or the movement of the digital camera 101 based on the user' s will, as well as the motion of a subject itself . The motion of an image increases as the subject becomes close to the digital camera 101. An addition intensity derived from a conversion table is changed using focus information obtained through driving control of the motor 209 by the control unit 307.

For example, when a subject is present at a distance within about 50 cm from the digital camera 101, a constant “0.6” is multiplied to an addition intensity derived from a conversion table, such that an addition intensity is set to be small. Otherwise, an addition intensity is not changed.

An addition intensity derived through the above-described procedure is stored in the addition intensity table 306 through a selection pointer 416. The number of records of the addition intensity table 306 is smaller than the number of pieces of digital image data stored in the image memory 302 by one. In this embodiment, since six pieces of digital image data are stored in the image memory 302, the number of records of the addition intensity table 306 is 5.

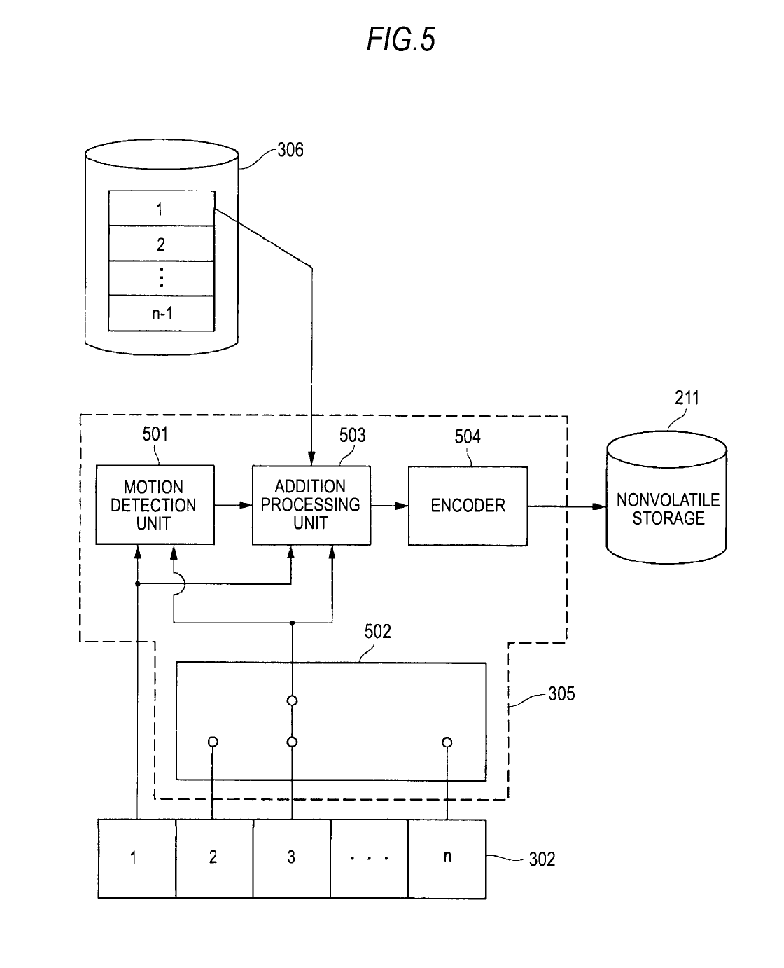

FIG. 5 is a functional block diagram of the developing processing unit 305.

A motion detection unit 501 sequentially reads six pieces of digital image data stored in the image memory 302 through a selection switch 502, detects how much the second or subsequent digital image data moves with respect to the first digital image data by a known block matching algorithm in detail, and calculates a motion vector.

An addition processing unit 503 performs addition processing on the basis of the motion vector obtained by the motion detection unit 501. At the time of the addition processing, the addition processing is performed using the value of the addition intensity table 306 created by the addition intensity calculation unit 304 as a coefficient when adding the second or subsequent digital image data.

If the addition processing unit 503 completes the addition processing, digital image data is converted in a known JPEG format or the like by an encoder 504 and recorded in the nonvolatile storage 211 in the form of files.

### [Operation]

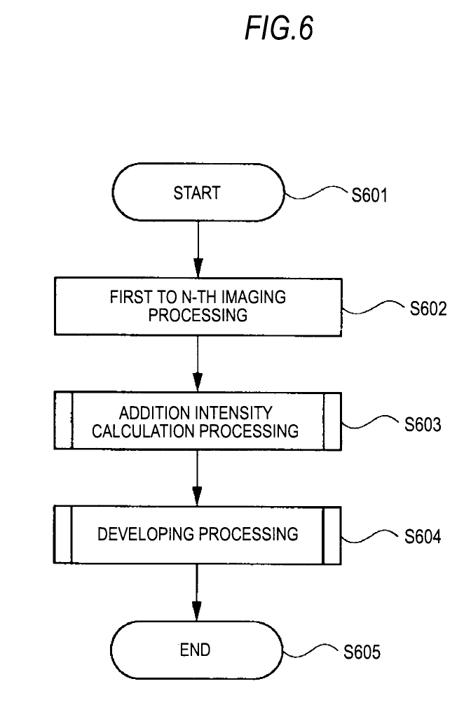

FIG. 6 is a flowchart showing the flow of an operation of imaging using sequential shooting, addition, and noise reduction in the digital camera 101 of this embodiment.

If the shutter button 106 is depressed (S601), initially, the imaging processing unit performs sequential imaging processing of n pieces of image data, and stores n pieces of image data in the image memory 302 (S602). Next, the addition intensity calculation unit 304 performs addition intensity calculation processing (S603). Finally, the developing processing unit 305 performs developing processing (S604), and ends a sequence of processing (S605).

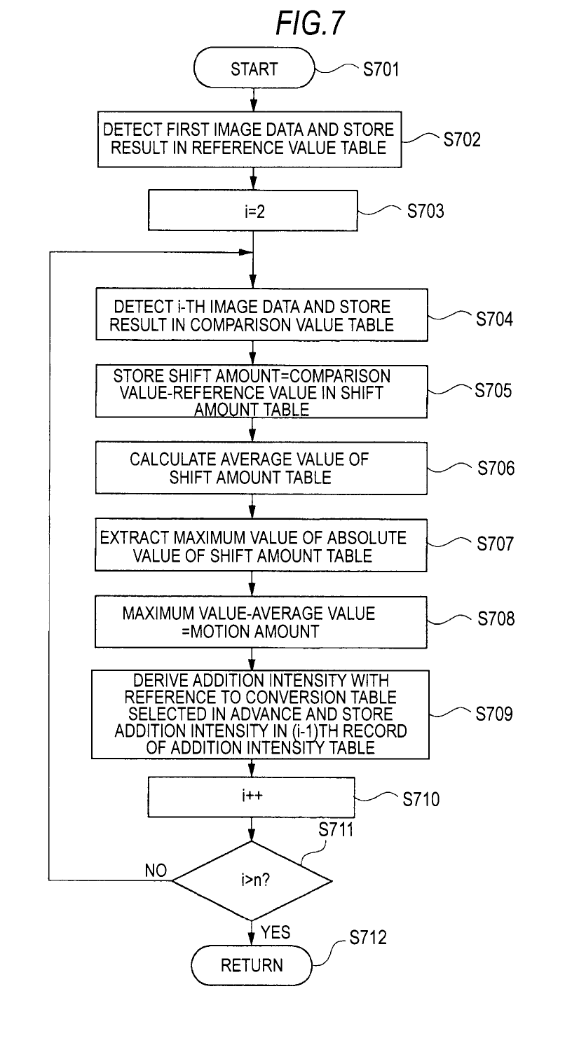

FIG. 7 is a flowchart showing the flow of an operation of addition intensity calculation processing in the addition intensity calculation unit 304. FIG. 7 shows the details of Step S603 of FIG. 6.

If the processing starts (S701), initially, the detection unit 401 reads the first image data in the image memory 302 through the selection switch 402 which is controlled by the control unit 307, and performs detection processing, that is, brightness calculation processing of a multi-pattern photometric frame. The value of the result of the brightness calculation processing is stored in the reference value table 404 through the switch 403 (S702).

Next, the control unit 307 provides a counter variable i in the RAM 204, and stores “2” as an initial value (S703).

The subsequent processing is loop processing. The detection unit 401 reads i-th image data in the image memory 302 through the selection switch 402 which is controlled by the control unit 307, and performs the detection processing. The value of the result of the brightness calculation processing is stored in the comparison value table 405 through the switch 403 which is controlled by the control unit 307 (S704).

If the value of the result of the brightness calculation processing is stored in all the records of the comparison value table 405, the first subtractor 406 subtracts the value of each record of the comparison value table 405 from the value of each record of the reference value table 404, and stores the obtained value in the shift amount table 407 (S705).

If the value of the arithmetic result of the first subtractor 406 is stored in all the records of the shift amount table 407, next, the average value calculation unit 408 calculates the average value of the values of all the records of the shift amount table 407, and stores the average value in the average value memory 410 (S706).

Next, after deriving the absolute values of the values of all the records of the shift amount table 407, the maximum value calculation unit 409 extracts the maximum value of the absolute value with reference to the average value stored in the average value memory 410 and stores the maximum value in the maximum value memory 411 (S707).

Through Steps S706 and S707, arrangement data (vector data) called the shift amount table 407 is converted to scalar values called the average value and the maximum value.

If the average value and the maximum value are respectively stored in the average value memory 410 and the maximum value memory 411, the second subtractor 412 subtracts the average value from the maximum value to calculate “motion amount” as a scalar value (S708).

The motion amount output from the second subtractor 412 is supplied to the addition intensity derivation unit 413. The addition intensity derivation unit 413 reads a conversion table of a corresponding imaging scene from the conversion table group 414 by scene through the selection pointer 415 on the basis of scene information obtained from the control unit 307. Next, the motion amount is checked against the conversion table to derive an addition intensity. A focal distance is obtained from the control unit 307 and compared with a threshold value set in advance. The threshold value is, for example, 50 cm. When the focal distance falls below the threshold value, an addition intensity should be set to be small, such that a predetermined coefficient set in advance is multiplied to the addition intensity. The coefficient is, for example, 0.7.

The addition intensity obtained in the above-described manner is stored in an i-th record of the addition intensity table 306 through the selection pointer 416 (S709).

Next, the control unit 307 increments the counter variable i (S710), and verifies whether or not the counter variable i exceeds the number of pieces of image data stored in the image memory 302 (S711). If the counter variable i is equal to or smaller than the number of pieces of image data (NO in S711), the processing is repeated from Step S704. If the counter variable i exceeds the number of pieces of image data (YES in S711), a sequence of processing ends (S712).

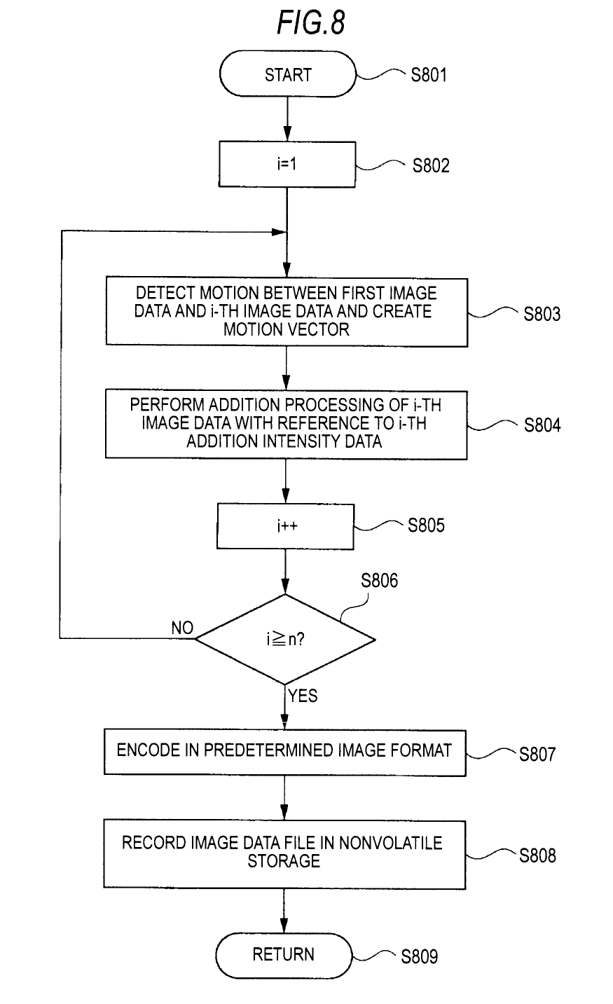

FIG. 8 is a flowchart showing the flow of an operation of developing processing in the developing processing unit 305. FIG. 8 shows the details of Step S604 of FIG. 6.

If the processing starts (S801), initially, the control unit 307 provides a counter variable i in the RAM 204 and stores “1” as an initial value (S802).

The subsequent processing is loop processing.

The motion detection unit 501 detects how much the i-th digital image data moves with respect to the first digital image data by a known block matching algorithm in detail through the selection switch 502 which is controlled by the control unit 307, and calculates a motion vector (S803).

Next, the addition processing unit 503 performs addition processing for adding the i-th digital image data to the first digital image data on the basis of the motion vector obtained by the motion detection unit 501. At the time of the addition processing, the value of the i-th record of the addition intensity table 306 created by the addition intensity calculation unit 304 is read, and the addition processing is performed using the read value as the coefficient for addition processing (S804).

Next, the control unit 307 increments the counter variable i (S805), and verifies whether or not the counter variable i is equal to or greater than the number of pieces of image data stored in the image memory 302 (S806). If the counter variable i is smaller than the number of pieces of image data (NO in S806) , the processing is repeated from Step S802. If the counter variable i is equal to or greater than the number of pieces of image data (YES in S806), the addition processing of the addition processing unit 503 ends. Thus, obtained image data is encoded in a predetermined image format (S807), an image data files is recorded in the nonvolatile storage 211 (S808), and a sequence of processing ends (S809).

With regard to this embodiment, the following applications can be made.

(1) The technology which is realized by the digital camera 101 of this embodiment is the improvement of sequential shooting, addition, and noise reduction. Referring to FIGS. 3 and 6, the technology is the improvement of image processing after imaging other than the processing of the imaging processing unit. Referring to FIG. 2, the technology is the improvement of the control program of the microcomputer and the arithmetic processing program of the DSP, that is, the improvement of software.

Accordingly, system construction is considered such that, with the use of the characteristic of a flash memory which tends to have high capacity in recent years, a digital camera itself carries out only sequential shooting without performing an image processing portion of sequential shooting, addition, and noise reduction, and the image processing portion is entrusted to an external information processing apparatus, such as a personal computer.

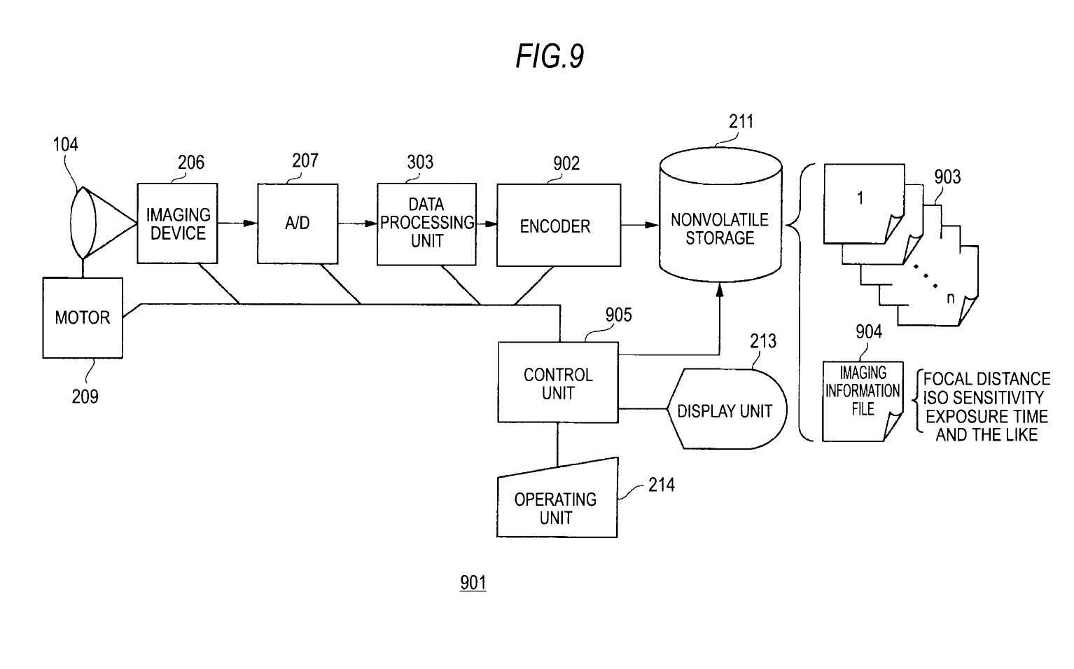

FIG. 9 is a functional block diagram of a digital camera. By comparison with the digital camera 101 of FIG. 3, a functional block relating to the improvement of sequential shooting, addition, and noise reduction, that is, the selection switch 301, the image memory 302, the addition intensity calculation unit 304, the addition intensity table 306, and the developing processing unit 305 are not provided.

A digital camera 901 shown in FIG. 9 carries out only a sequential shooting function, and an encoder 902 performs encoding processing using a lossless compression algorithm so as to prevent image deterioration. That is, image data files 903 obtained through sequential shooting are recorded in the nonvolatile storage 211 in a format, such as JPEG EX, PNG, or TIFF, using a lossless compression algorithm, instead of JPEG based on a known lossy compression scheme. It is necessary to store at least focal distance information separately as imaging information at that time. Imaging information is described in an imaging information file 904 and recorded in the nonvolatile storage 211.

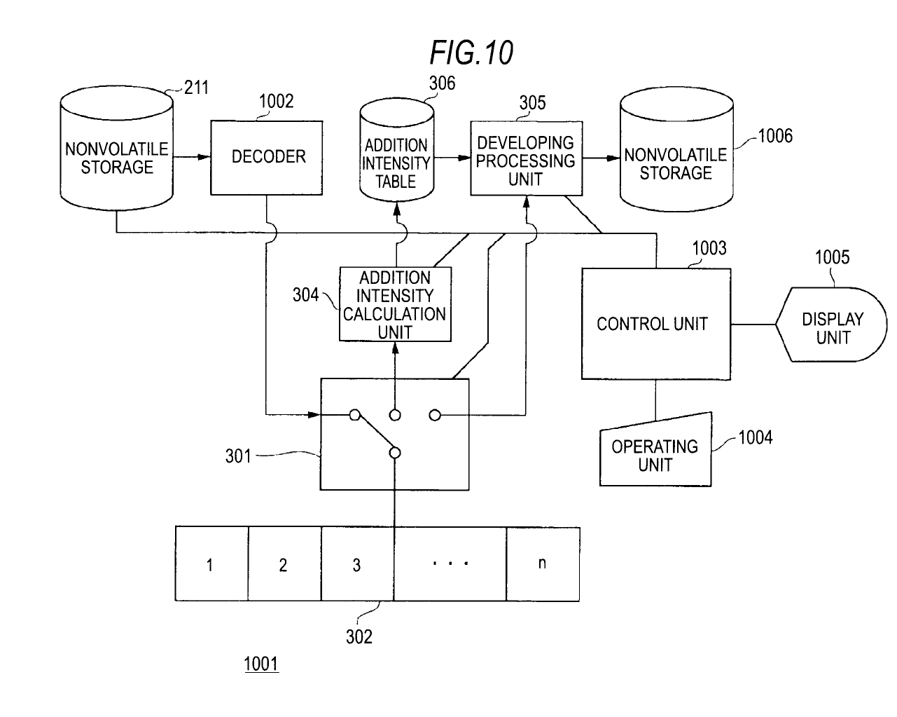

FIG. 10 is a functional block diagram of an image processing apparatus. A personal computer reads and executes a program relating to image processing of sequential shooting, addition, and noise reduction, such that the personal computer realizes the functions of an image processing apparatus 1001.

The nonvolatile storage 211, such as a flash memory, detached from the digital camera 901 is connected to the personal computer through an interface (not shown) or the digital camera 901 is connected to the personal computer through the USB interface 212, such that the nonvolatile storage 211 is connected to a decoder 1002 in the personal computer. The decoder 1002 reads the image data files 903 as the result of sequential shooting stored in the nonvolatile storage 211, converts the image data files to raw image data, and stores raw image data in the image memory 302 through the selection switch 301. Since there is the imaging information file 904 in the nonvolatile storage 211, the control unit 1003 reads the imaging information file 904 and acquires the focal distance.

The operation after image data is stored in the image memory 302 is the same as the digital camera 101 of FIG. 3.

If the digital camera 901 and the image processing apparatus 1001 are configured as above, it is advantageous in that the user of a previous-generation digital camera can substantially enjoy the function of sequential shooting, addition, and noise reduction only by updating firmware to mount an encoder using a sequential shooting function and a lossless compression algorithm in the previous-generation digital camera having insufficient arithmetic processing ability.

The image processing apparatus 1001 of FIG. 10 is an apparatus which performs post-processing using the captured image data files 903 and the imaging information file 904. Thus, the addition intensity calculation unit 304 runs while changing an imaging scene to be set, such that the processing of sequential shooting, addition, and noise reduction can be started again as many times as necessary. In general, since the personal computer has high arithmetic ability compared to the digital camera 901, if design is made such that the post-processing portion is separated from the digital camera 901 and entrusted to the personal computer, it should suffice that the digital camera 901 has only the high-capacity nonvolatile storage 211 and the encoder 902 of the lossless compression algorithm. That is, since the digital camera 901 may not have massive arithmetic ability, this can contribute to further reduction in the size of the digital camera 901 itself and low power consumption.

(2) Any multi-pattern photometric frame may be used in the detection processing of the detection unit 401 insofar as a rough motion of the entire screen can be detected, and a frame larger than a frame for motion detection in the motion detection unit 501 may be used. The aspect ratio of the multi-pattern photometric frame may not be the same as the aspect ratio of the entire screen.

(3) In Step S804 of FIG. 8, when the addition processing unit 503 performs the addition processing, as the result of comparing the addition intensity read from the addition intensity table 306 with a predetermined threshold value, if the addition intensity falls below the threshold value, it can be determined that the addition processing is meaningless. For this reason, it is possible to further provide processing such that subsequent addition processing is not performed. For example, when the addition intensity corresponding to the third image data is smaller than a threshold value “0.2”, it can be determined that further addition processing is meaningless. From the viewpoint of “sequential shooting”, there is no possibility that the motion of subsequent image data decreases. In other words, there is no possibility that the addition intensity corresponding to subsequent image data exceeds the threshold value. Thus, if it is determined that the addition processing is not performed on the third image data, the addition processing itself is terminated, thereby saving the processing in the motion detection unit 501 and the addition processing unit 503 and reducing the time necessary for the entire developing processing.

(4) A predetermined function or pseudo function, instead of a conversion table, may be set in the conversion table group 414 by scene, and the addition intensity may be continuously changed with respect to changes in the arithmetic result of the second subtractor 412.

(5) A bias function which changes to correspond to the focal distance may be set in the addition intensity derivation unit 413, and the addition intensity may be continuously changed with respect to changes in the focal distance.

In this embodiment, the digital camera and the image processing apparatus are described.

In carrying out sequential shooting, addition, and noise reduction, the average value of brightness in each multi-pattern photometric frame is calculated, and the shift amount between the average value of brightness of the entire screen and the maximum value of the absolute value is calculated and set as the index for the motion of the entire screen. An addition intensity is calculated with reference to a conversion table and a focal distance according to an imaging scene and set as the coefficient for addition processing.

In imaging a subject to which sequential shooting, addition, and noise reduction of the related art is not easily applied, and which has a small amount of texture, a short focal distance, and a large number of motions, a possibility that failure occurs in detecting a motion vector based on block matching is derived as a coefficient for addition processing through processing with a small amount of calculation and excluded by weakening the addition processing, making it possible to prevent image disturbance due to addition irregularity.

Although the embodiment of the present disclosure has been described, the present disclosure is not limited to the foregoing embodiment, and other modifications and applications may be made without departing from the scope of the present disclosure described in the appended claims.

The present disclosure contains subject matter related to that disclosed in Japanese Priority Patent Application JP 2010-153119 filed in the Japan Patent Office on Jul. 5, 2010, the entire contents of which is hereby incorporated by reference.

What is claimed is:

1. An image processing apparatus comprising:
an addition intensity calculation unit which calculates an addition intensity on the basis of a difference between first image data included in a plurality of pieces of image data obtained through sequential shooting and second image data included in the plurality of pieces of image data; and
an addition processing unit which performs addition processing of the first image data and the second image data on the basis of the addition intensity.

2. The image processing apparatus according to claim 1,
wherein the first image data is image data based on first imaging in the sequential shooting,
the addition intensity calculation unit calculates an addition intensity on each piece of image data on the basis of a difference between the first image data and each piece of image data included in the plurality of pieces of image data excluding the first image data, and
the addition processing unit performs addition processing of the first image data and the plurality of pieces of image data excluding the first image data on the basis of the addition intensity on each piece of image data.

3. The image processing apparatus according to claim 2,
wherein the difference is detected on the basis of brightness detected in each multi-pattern photometric frame.

4. The image processing apparatus according to claim 1,
wherein the addition intensity calculation unit calculates the addition intensity on each piece of image data on the basis of focus information corresponding to each piece of image data.

5. The image processing apparatus according to claim 1,
wherein the addition intensity calculation unit calculates the addition intensity on the basis of an imaging scene when image data is taken.

6. The image processing apparatus according to claim 1,
wherein the addition processing unit performs addition processing of the plurality of pieces of image data in order of imaging in the sequential shooting, and when the addition intensity is smaller than a predetermined value, terminates subsequent addition processing.

7. An image processing method comprising:
calculating an addition intensity on the basis of a difference between first image data included in a plurality of pieces of image data obtained through sequential shooting and second image data included in the plurality of pieces of image data; and
performing addition processing of the first image data and the second image data on the basis of the addition intensity.

8. An image processing program which causes a computer to function as an image processing apparatus,
wherein the image processing apparatus includes
an addition intensity calculation unit which calculates an addition intensity on the basis of a difference between first image data included in a plurality of pieces of image data obtained through sequential shooting and second image data included in the plurality of pieces of image data, and
an addition processing unit which performs addition processing of the first image data and the second image data on the basis of the addition intensity.
